(19) United States
(12) Patent Application Publication
(10) Pub. No.: US 2026/0186159 A1
(43) Pub. Date: Jul. 2, 2026

(54) SUBSURFACE RESERVOIR CHARACTERIZATION

(71) Applicant: Saudi Arabian Oil Company, Dhahran (SA)

(72) Inventors: Xiaoxi Wang, Beijing (CN); Wisam AlKawai, Qatif (SA)

(21) Appl. No.: 19/008,454

(22) Filed: Jan. 2, 2025

(51) Int. Cl. G01V 1/30

(52) U.S. Cl. CPC G01V 1/30; G01V 2210/624; G01V 2210/66

(57) ABSTRACT

Example methods and systems for subsurface reservoir characterization are disclosed. One example method includes obtaining facies data of rock formations of a subsurface reservoir, where the facies data is from a forward stratigraphic modeling (FSM) process applied to the subsurface reservoir. A compaction-porosity model and an acoustic impedance-porosity model are selected from a library of rock physics models based on the facies data. An acoustic impedance model of the rock formations of the subsurface reservoir is determined based on the compaction-porosity model and the acoustic impedance-porosity model. The acoustic impedance model is provided for hydrocarbon exploration of the subsurface reservoir.

### TECHNICAL FIELD

The present disclosure relates to computer-implemented methods and systems for subsurface reservoir characterization.

### BACKGROUND

Forward stratigraphic modeling (FSM) can simulate the processes of sediment transport, erosion, and/or deposition over geologic time and predict spatial distribution of lithofacies, subsurface reservoir architecture, and/or petrophysical parameters (e.g., porosity), using techniques such as diffusion, physical numerical equations (e.g., Navier-Stokes), fuzzy logic, and/or geometrical relationships. The resulting models can provide input for hydrocarbon exploration to determine where to drill exploration and/or development wells, and to improve assessment of hydrocarbon storage.

### SUMMARY

The present disclosure involves methods and systems for subsurface reservoir characterization. One example method includes obtaining facies data of rock formations of a subsurface reservoir, where the facies data is from a forward stratigraphic modeling (FSM) process applied to the subsurface reservoir. A compaction-porosity model and an acoustic impedance-porosity model are selected from a library of rock physics models based on the facies data. An acoustic impedance model of the rock formations of the subsurface reservoir is determined based on the compaction-porosity model and the acoustic impedance-porosity model. The acoustic impedance model is provided for hydrocarbon exploration of the subsurface reservoir.

The previously described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, obtaining the facies data of rock formations includes decoding the facies data to obtain decoded facies data of the rock formations of the subsurface reservoir, and a format of the decoded facies data is compatible with the acoustic impedance-porosity model.

In some implementations, selecting, based on the facies data, the compaction-porosity model and the acoustic impedance-porosity model includes selecting, based on the decoded facies data, the compaction-porosity model and the acoustic impedance-porosity model.

In some implementations, selecting the compaction-porosity model and the acoustic impedance-porosity model includes selecting, based on input data from a graphical user interface (GUI), the compaction-porosity model and the acoustic impedance-porosity model.

In some implementations, at least one of the compaction-porosity model or the acoustic impedance-porosity model is a customized model from a user.

In some implementations, the compaction-porosity model includes a porosity-depth function of the rock formations, and the porosity-depth function is based on Athy's law or a Schneider model.

In some implementations, the acoustic impedance-porosity model includes an acoustic impedance-porosity function of the rock formations, and the acoustic impedance-porosity function is based on one of a stiff sand model, a friable sand model, a constant cement model, a differential effective medium model, and an empirical model.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates an example process of determining wellbore fluid saturation distribution for well steering, according to some implementations.

FIG. 2 illustrates an example graphical user interface (GUI) for decoding data in an output file from forward stratigraphic modeling (FSM) and recovering decoded depositional properties, according to some implementations.

FIGS. 3A-3D illustrate example three-dimensional (3D) surface maps of depositional properties decoded in layers from an output file that includes FSM results, according to some implementations.

FIG. 4 illustrates an example interface for defining facies names, according to some implementations.

FIG. 5 illustrates an example interface showing saved compaction-porosity models, according to some implementations.

FIG. 6 illustrates an example interface showing saved acoustic impedance-porosity models, according to some implementations.

FIG. 7 illustrates an example interface that shows information of functions in a rock physics library module, according to some implementations.

FIG. 8 illustrates an example interface for loading decoded facies data and saved customized rock physics models, according to some implementations.

FIG. 9 illustrates an example interface that shows determined acoustic impedance, according to some implementations.

FIG. 10 illustrates an example of 3D surface mapping of acoustic impedance model in layers, according to some implementations.

FIG. 11 illustrates an example of exported ASCII files of a determined acoustic impedance model, according to some implementations.

FIG. 12 illustrates an example process for determining acoustic impedance based on forward stratigraphic modeling, according to some implementations.

FIG. 13 is a block diagram of an example computer system that can be used to provide computational functionalities associated with described algorithms, methods, functions, processes, flows, and procedures, according to some implementations.

FIG. 14 illustrates hydrocarbon production operations that include both one or more field operations and one or more computational operations, which exchange information and control exploration for the production of hydrocarbons, according to some implementations.

Like reference numbers and designations in the various drawings indicate like elements.

### DETAILED DESCRIPTION

Forward stratigraphic modeling of rock formations can guide predictions of rock geometries and architectures of subsurface reservoirs and involve techniques such as diffusion, physical numerical equations (e.g., Navier-Stokes), fuzzy logic, and/or geometrical relationships to model sediment transport, erosion, and/or deposition over geologic time. The parameters of input to forward stratigraphic modeling can be related to a paleo-environment back in geologic time, such as sea level, sediment supply, and/or subsidence/uplift, and therefore can have significant uncertainties. To reduce the impact of uncertainties in the input parameters, forward stratigraphic modeling (FSM) models can be calibrated using well data such as wireline logs and/or core data. The calibration of FSM can offer a spatially limited control in the case of paucity of well data, for example, in frontier basins. In some cases, calibration of FSM using seismic data, after transforming results from FSM into acoustic impedance using rock physics models, can improve the calibration of FSM.

This disclosure describes systems and methods for determining acoustic impedance of rock formations in subsurface reservoirs (i.e., acoustic impedance modeling) by assigning rock physics models to results, for example, facies, from forward stratigraphic modeling. A facies is a body of rock with distinctive characteristics and can encompass different characteristics of a rock, such as chemical, physical, and biological features of the rock that distinguish the rock from adjacent rocks. In some cases, a user interface, for example, a graphical user interface (GUI), can be used during the acoustic impedance modeling to render the transformation of FSM results into acoustic impedance models more efficient and user-friendly.

The disclosed system can include three modules. The first module decodes the data files that include the results of FSM (e.g., facies) of the rock formations. The second module includes a rock physics library of rock physics models of different rock formations. These models include porosity compaction curves as well as transforms of porosity into acoustic impedance. The rock physics library can allow a user to validate rock physics models with customized data and to save models built with the customized data. The third module determines acoustic impedance by assigning rock physics models in the library to the facies resulting from FSM.

The disclosed method can avoid manually decoding and extracting data for the rock physics models, and can provide rock physics models of different rock formations and offer users a GUI to define and save customized physical compaction equations and/or acoustic impedance-porosity equations. The acoustic impedance modeling can be conducted by interactive operations through the GUI.

The disclosed systems and methods provide many advantages over existing systems. As an example, the disclosed method can reduce uncertainties in the results of FSM by predicting reservoir architecture in a robust manner. The disclosed method can increase the accuracy of the FSM results by comparing acoustic impedance generated from FSM to acoustic impedance from seismic data. As another example, the disclosed method can improve the results of seismic inversion by conditioning seismic inversion using the results from FSM.

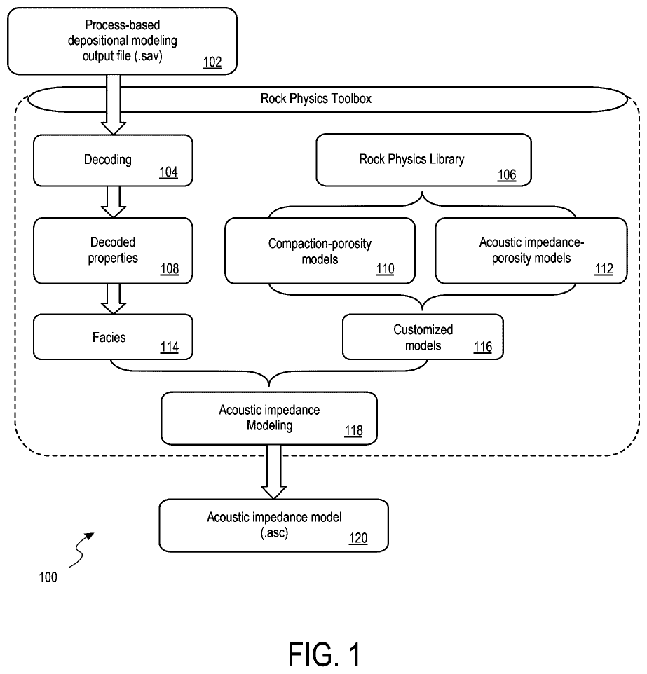

FIG. 1 illustrates an example system 100 for determining acoustic impedance of rock formations of a subsurface reservoir, according to some implementations. System 100 can integrate data decoding module 104 with rock physics library module 106. In some implementations, data decoding module 104 can enable decoding of data in data file 102 that includes the results of FSM, resulting in decoded properties 108 and decoded facies 114. In some cases, data decoding module 104 can decode data file 102 by converting the format of the data (e.g., facies in the results of FSM) in data file 102 to another format that can be used in acoustic impedance modeling module 118, or extracting properties 108 of the data in data file 102 from data file 102, such that decoded facies 114 can represent the internal data arrays of the data in data file 102, and can be used in acoustic impedance modeling module 118. In some cases, the conversion process can include analyzing data organization structure of the data in data file 102 (e.g., analyzing the meaning of the data and how the data is structured in a data array) and/or extracting the data from data file 102 and resaving the extracted data in a format or an array suitable for subsequent processing (e.g., extracting facies data in data file 102 and using the extracted data for further calculation). In some cases, the file type of data file 102 can be unique for some FSM software.

In some implementations, rock physics library module 106 includes a library of rock physics models of different rock formations. The rock physics models can include porosity compaction curves of rock formations in a subsurface reservoir, for example, compaction-porosity models 110 (also referred to as porosity compaction models), as well as transforms of porosity of the rock formations into acoustic impedance of the rock formations, for example, acoustic impedance-porosity models 112.

In some implementations, compaction-porosity models 110 can describe the reduction of porosity of a rock formation with burial after deposition of the rock formation due to mechanical compaction. The mechanical compaction can occur as the overburden load increases and the associated effective stress increases. Therefore, the porosity can be modeled as a function of depth of the rock formation, assuming hydrostatic conditions.

In some implementations, rock physics library module 106 can allow a user to validate compaction-porosity models 110 and/or acoustic impedance-porosity models 112 with customized data, and/or save customized models 116, which can include compaction-porosity models 110 and/or acoustic impedance-porosity models 112 that have been customized by a user, e.g., for specific areas of a region that are of interest to the user.

In some implementations, acoustic impedance modeling module 118 can calculate acoustic impedance of rock formations by assigning rock physics models in rock physics library module 106, i.e., compaction-porosity models 110 and/or acoustic impedance-porosity models 112, to decoded facies 114 resulted from FSM. In some cases, different rock facies can have different rock physics models saved in the rock physics library module 106. For example, mud rock, sand rock, and carbonate rock belong to different rock facies that have different rock physics models.

In some implementations, system 100 can reduce the uncertainty in the results of FSM and consequently predict reservoir architecture in a robust manner. System 100 can also improve the results of seismic inversion by conditioning the seismic inversion using the results from FSM. System 100 can be applied to various types of commercial FSM engines, for example, DionisosFlow® (IFPEN/Beicip-Franlab).

In some implementations, the results from FSM can be saved in date file 102, which can be used as input data for acoustic impedance modeling.

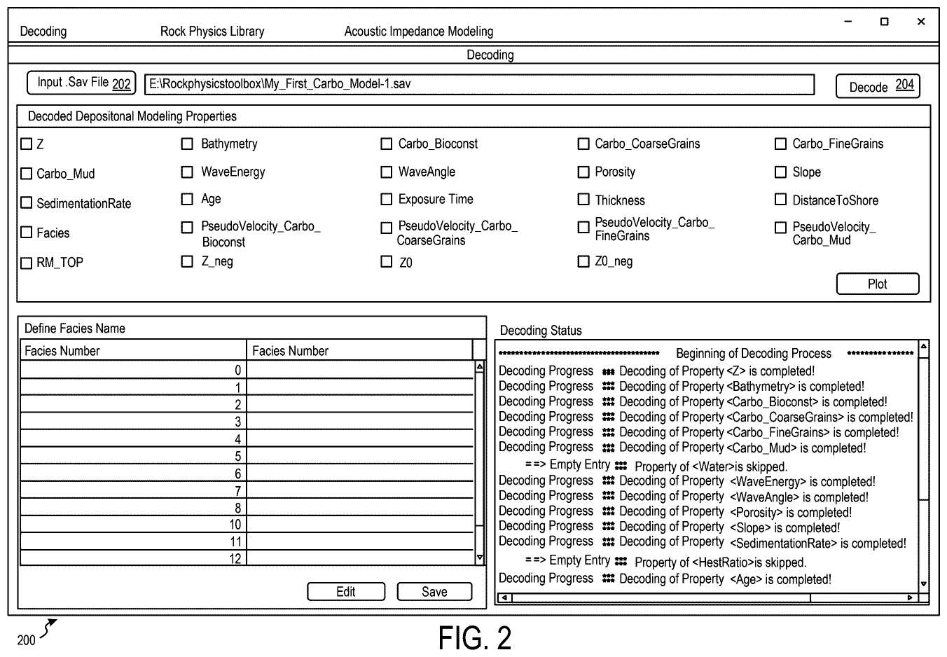

FIG. 2 illustrates an example GUI 200 for decoding data in output file 102 and recovering decoded depositional properties 108, according to some implementations. In some implementations, the button “Input. sav File” 202 is for a file navigator that helps find target output file 102 to be analyzed. The button “Decode” 204 is for decoding data in the specified output file 102. The names of the analyzed properties can be displayed in GUI 200. The numbers of the decoded facies 114 can be displayed in GUI 200 in FIG. 2. To display three-dimensional (3D) surface maps of geometries and properties 108 of FSM, a user can check one or more properties and then select the “Plot” button.

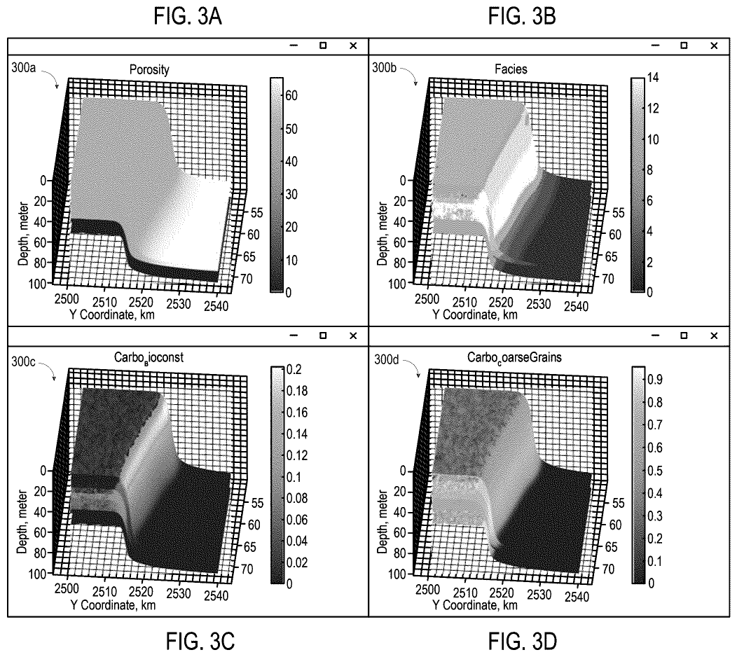

FIGS. 3A to 3D illustrate example 3D surface maps 300a to 300d, respectively, of properties 108 decoded in layers from output file 102 that includes the FSM results, according to some implementations. FIG. 3A shows an example of decoded porosity of rock formations at various depths (i.e., layers). The decoded porosity can be used in compaction-porosity modeling and/or acoustic impedance-porosity modeling. FIG. 3B shows an example of decoded facies of the rock formations at various depths. The decoded facies can be used when assigning rock physics models to the decoded facies for determining acoustic impedance of the rock formations. FIGS. 3C and 3D show examples of decoded properties of the rock formations at various depths. FIGS. 3A to 3D can help users to obtain the proportions of different types of sediments. The proportions can be related to the distribution of rock facies.

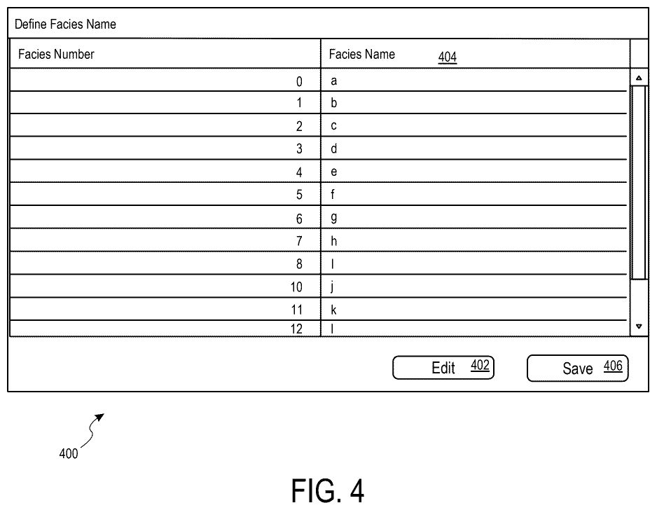

In some implementations, the facies name information is not saved in output file 102, and an interface for defining facies names can be made available in GUI 200. FIG. 4 illustrates an example interface 400 for defining facies names, according to some implementations. A user can select the “Edit” button 402 and type in the facies names 404 in GUI 200 for each facies name and then select the “Save” button 406.

In some implementations, rock physics library module 106 can provide a customized library, in which users can define their own equations of compaction-porosity models 110 and acoustic impedance-porosity models 112 for different facies. In some implementations, rock physics library module 106 can include multiple types of compaction-porosity models 110.

One type of compaction-porosity model 110 is a Athy's law-based model. Athy's law describes an exponential decrease of porosity with depth of the rock formation. A modified version of Athy's law, as shown in Equation 1 below, describes the porosity compaction curve as having a non-zero porosity.

$$φ ( z ) = {φ}_{m} + ( {φ}_{0} - {φ}_{m} ) {e}^{- k z} , \qquad ( 1 )$$

where φ(z) is the porosity as a function of depth z, φₘ is the minimum porosity, φ₀ is the initial porosity at the time of deposition and k is the compaction coefficient.

Another type of compaction-porosity model is a Schneider model, which is an extension of a Athy's law-based model and includes two exponential terms are shown in Equation 2 below.

$$φ ( z ) = {φ}_{1} + {φ}_{a} {e}^{- {k}_{a} z} + {φ}_{b} {e}^{- {k}_{b} z} , \qquad ( 2 )$$

where φ(z) is the porosity as a function of depth z. The sum of the three porosity values in Equation 2 φ₁+φₐ+φ_{b} is equal to the initial porosity, φ₀, in Equation 1. φₐ and φ_{b} can be half of the initial porosity. kₐ and k_{b} are compaction coefficients.

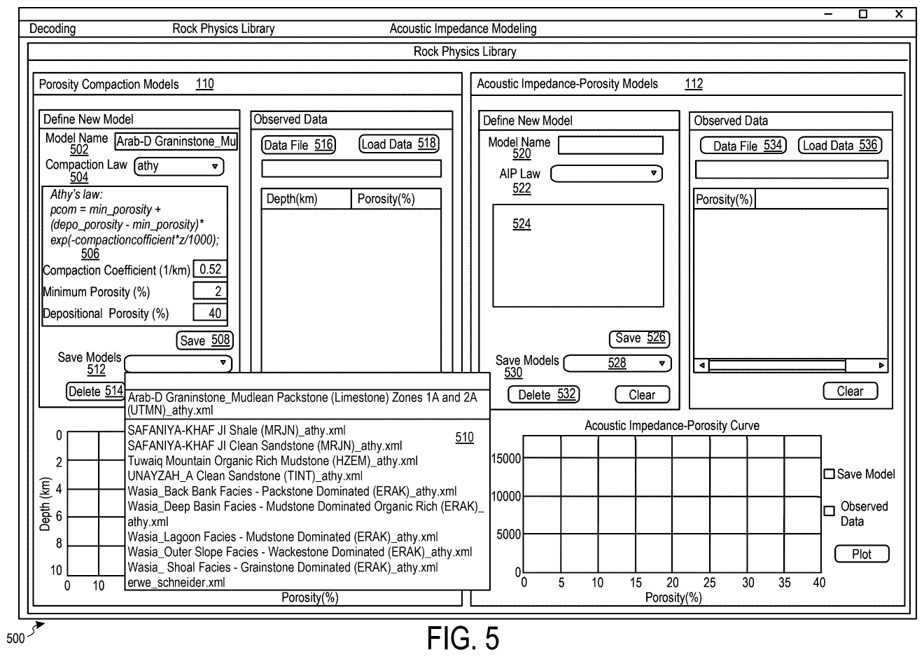

FIG. 5 illustrates an example interface 500 showing saved compaction-porosity models 110, according to some implementations. In some implementations, to define a new compaction-porosity model 110, a user can provide the model's name 502, select the compaction law 504 (e.g., Athy's law or Schneider model), provide the parameter values 506 required in the selected compaction law, and select the “Save” button 508. The new compaction-porosity models will be listed in the drop-down box 510 of the “Saved model” 512.

In some implementations, to display the parameters of a saved compaction-porosity model, a user can choose a model name in the drop-down box 510 of the “Saved Model” 512. To delete the selected model from the saved model list, a user can select the “Delete” button 514 after choosing the model name in the drop-down box 510 of the “Saved Model” 512.

In some implementations, rock physics library module 106 can include multiple types of acoustic impedance-porosity models 112 (e.g., stiff sand model, friable sand model, constant cement model, differential effective medium model, and/or empirical model). These models are described below.

In some implementations, rock physics models describing variations of elastic moduli and seismic velocity values of different porosities can be used to model relationships between acoustic impedance and porosity. The rock physics models can be modified versions of Hashin and Shtrikman bounds except for differential effective medium models and empirical models. The modified versions of Hashin and Shtrikman bounds can define the ranges of elastic moduli of an isotropic linear elastic composite at different concentrations of the constituents regardless of the geometries of the constituents. In some cases, rock physics models can be transforms derived from elasticity theories such as Hashin and Shtrikman bounds. The rock physics models require calibration of inputs such as mineralogical composition, saturating pore fluid, and/or effective pressure. The inputs can be calibrated to well data, for example, wireline logs, X-Ray diffraction analysis (XRD) data, cuttings data, and/or pressure measurements such as repeat formation tester (RFT) data.

In some implementations, rock physics models, except for the empirical model, can first calculate the elastic moduli of the dry rock and then apply the Gassman equation to calculate the elastic moduli of the saturated rock, as shown in Equations 3 and 4 below.

$$\frac{{K}_{sat}}{{K}_{0} - {K}_{sat}} = \frac{{K}_{dry}}{{K}_{0} - {K}_{dry}} + \frac{{K}_{fl}}{φ ( {K}_{0} - {K}_{fl} )} \qquad ( 3 )$$

$${μ}_{sat} = {μ}_{dry} \qquad ( 4 )$$

where Kₛₐₜ and μₛₐₜ are respectively the bulk and shear modulus of the saturated rock, K_{dry} and μ_{dry} are respectively the bulk and shear modulus of the dry rock, K₀ is the bulk modulus of the mineral matrix, K_{fl} is the bulk modulus of the saturating pore fluid, and φ is the porosity of the rock.

In some implementations, the rock physics model can be a stiff sand model, which is a modified upper Hashin-Shtrikman bound to drive the bulk and shear modulus of dry rock. The bulk and shear modulus at zero porosity, k and μ, can be calculated by the volumetrically weighted Reuss average. The elastic moduli values, k_{HM} and μ_{HM}, at the critical porosity, φ_{c}, can be calculated using Hertz-Mindlin theory. Between the two end member values at zero and critical porosity, the rest of elastic moduli values at other porosity values are interpolated using Equations 5 and 6 below.

$${k}_{eff} = {[ \frac{φ / {φ}_{c}}{{k}_{HM} + \frac{3}{4} μ} + \frac{1 - φ / {φ}_{c}}{k + \frac{3}{4} μ} ]}^{- 1} - \frac{3}{4} μ \qquad ( 5 )$$

$${μ}_{eff} = {[ \frac{φ / {φ}_{c}}{{μ}_{HM} + \frac{μ}{6} ( \frac{9 k + 8 μ}{k + 2 μ} )} + \frac{1 - φ / {φ}_{c}}{{μ}_{HM} + \frac{μ}{6} ( \frac{9 k + 8 μ}{k + 2 μ} )} ]}^{- 1} - \frac{μ}{6} ( \frac{9 k + 8 μ}{k + 2 μ} ) \qquad ( 6 )$$

In some implementations, the rock physics model can be a friable sand model, which is a modified lower Hashin-Shtrikman bound. The model can describe the velocity-porosity behavior versus different sorting at a specific effective pressure. The model can calculate elastic moduli values at end member porosities in a way similar to that of the stiff sand model, but interpolate between the calculated elastic moduli values using Equations 7 and 8 below.

$${k}_{eff} = {[ \frac{φ / {φ}_{c}}{{k}_{HM} + \frac{4}{3} {μ}_{HM}} + \frac{1 - φ / {φ}_{c}}{k + \frac{4}{3} {μ}_{HM}} ]}^{- 1} - \frac{4}{3} {μ}_{HM} \qquad ( 7 )$$

$${μ}_{eff} = {[ \frac{φ / {φ}_{c}}{{μ}_{HM} + \frac{{μ}_{HM}}{6} ( \frac{9 {k}_{HM} + 8 {μ}_{HM}}{{k}_{HM} + 2 {μ}_{HM}} )} + \frac{1 - φ / {φ}_{c}}{μ + \frac{{μ}_{HM}}{6} ( \frac{9 {k}_{HM} + 8 {μ}_{HM}}{{k}_{HM} + 2 {μ}_{HM}} )} ]}^{- 1} - \frac{{μ}_{HM}}{6} ( \frac{9 {k}_{HM} + 8 {μ}_{HM}}{{k}_{HM} + 2 {μ}_{HM}} ) \qquad ( 8 )$$

In some implementations, the rock physics model can be a constant cement model, which is a modified lower Hashin-Shtirkman bound following the interpolation form of Equations 7 and 8. However, the constant cement model can calculate the bulk and shear modulus at critical porosity based on a contact-problem solution by Dvorkin. The constant cement model can describe velocity-porosity versus different sorting at a specific cement volume.

In some implementations, the rock physics model can be a differential effective medium (DEM) model, which can model elastic moduli of porous medium by treating pores as inclusions. In DEM models the pores can be modeled as identical ellipses distributed in a mineral matrix, and the geometry of the ellipsoidal pores can be described by a constant aspect ratio. The model can start with a pure mineral matrix containing no pores and incrementally increase the concentration of pores at the subsequent steps.

The effective bulk and shear modulus k*(y) and μ*(y) are functions of the porosity y and are calculated by a system of ordinary differential equations. See, for example, Equations 9 and 10 below.

$$( 1 - y ) \frac{d [ {k}^{*} ( y ) ]}{d y} = ( {k}_{2} - {k}^{*} ) {P}^{( * 2 )} ( y ) \qquad ( 9 )$$

$$( 1 - y ) \frac{d [ {y}^{*} ( y ) ]}{d y} = ( {μ}_{2} - {μ}^{*} ) {Q}^{( * 2 )} ( y ) \qquad ( 10 )$$

where k₂ and μ₂ are bulk and shear modulus of the pores, and P and Q are coefficients related to the shape of the pores dictated by the aspect ratio. The initial condition to solve the equation is k*(0)=k₁ and μ*(0)=μ₁ where k₁ and μ₁ are bulk and shear modulus of the pure mineral matrix with no pores.

In some implementations, acoustic impedance can be modeled as a function of porosity by fitting available data. An empirical relationship between acoustic impedance and porosity can be modeled, for example, by a user, as a polynomial up to a second degree.

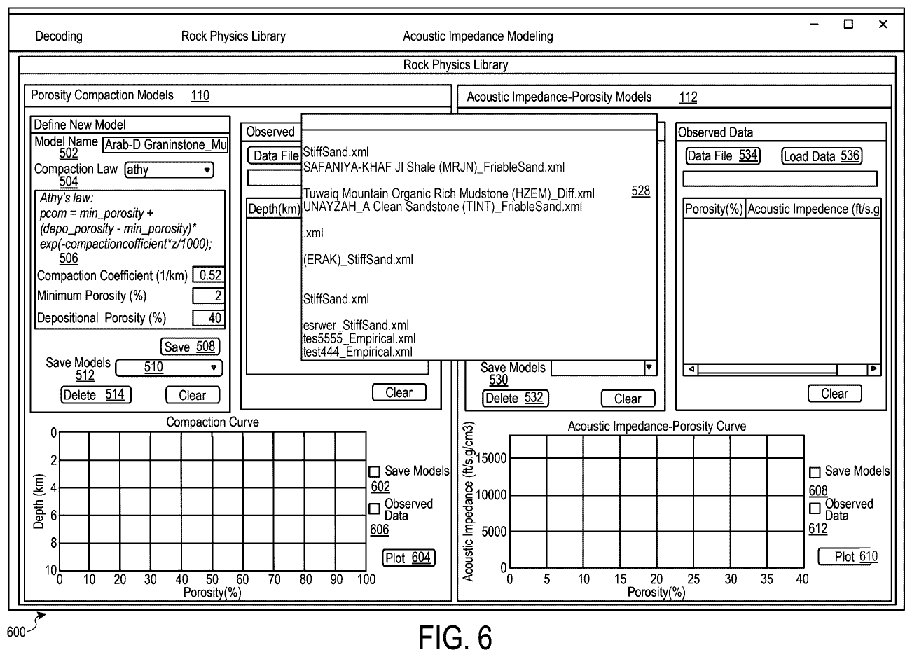

FIG. 6 illustrates an example interface 600 showing saved acoustic impedance-porosity models 112, according to some implementations. In some implementations, to define a new acoustic impedance-porosity model, a user can provide the model's name 520, select the acoustic impedance-porosity (AIP) Law 522, provide the parameter values 524 required in the selected AIP law, and then select the “Save” button 526. The new acoustic impedance-porosity models will be listed in the drop-down box 528 of the “Saved model” 530.

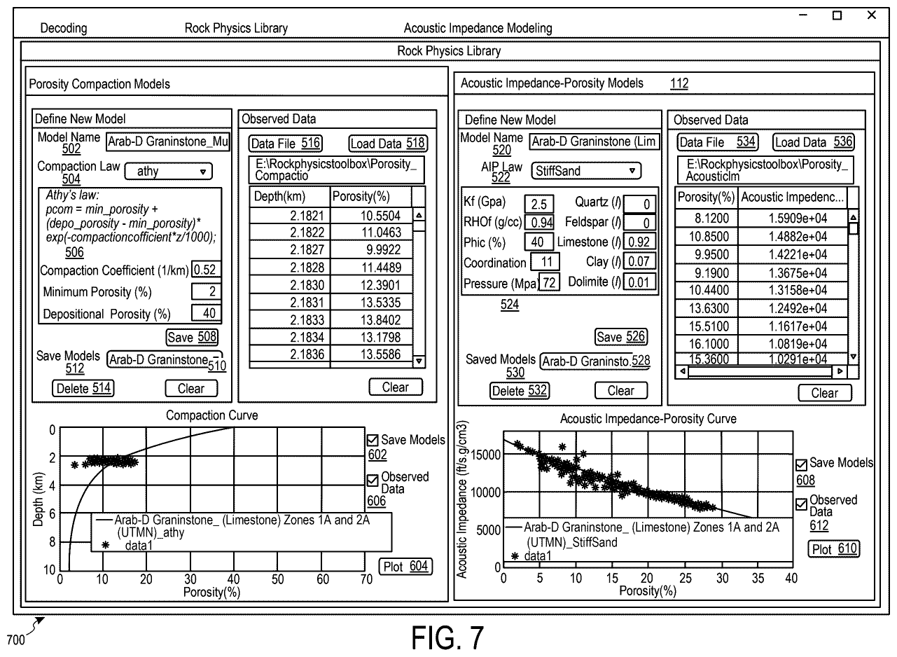

FIG. 7 illustrates an example interface 700 that shows information of functions in rock physics library module 106, according to some implementations. In some implementations, to display a porosity compaction curve of a compaction-porosity model, a user can select one of the saved models by choosing the model name in the drop-down box 510 of the “Saved Model” 512, check the “Saved Model” checkbox 602, and then select the “Plot” button 604.

In some implementations, to display a porosity compaction curve corresponding to observed data, a user can select the “Data File” button 516 to import a target observed data file, select “Load Data” button 518, and check the “Observed Data” checkbox 606 to display the observed data in interface 700. In some cases, the observed data can be prepared in a digital spreadsheet in which the observed data can be entered into columns such that one column includes the depth values in meters and the other column includes the corresponding porosity values expressed in percentage.

In some implementations, to display the parameters 524 of a saved acoustic impedance-porosity model, a user can choose a model name in the drop-down box 528 of the “Saved model” 530. To delete a model from the saved model list, a user can select the “Delete” button 532 after choosing the model name in the drop-down box 528 of the “Saved model” 530.

In some implementations, to display the acoustic impedance-porosity curve of one of the saved acoustic impedance-porosity models, a user can select the model by choosing the model name in the drop-down box 528 of the “Saved model” 530, check the “Saved Model” checkbox 608, and then click the “Plot” button 610.

In some implementations, to display an acoustic impedance-porosity curve corresponding to observed data, a user can select the “Data File” button 534 to import a target observed data file, select “Load Data” 536, and check the “Observed Data” checkbox 612 to display the data in interface 700. In some cases, the observed data can be prepared in a digital spreadsheet in which the observed data can be entered into columns such that one column includes porosity values expressed in percentage, and the other column includes the corresponding acoustic impedance values.

In some implementations, acoustic impedance modeling module 118 can establish an acoustic impedance model for decoded facies from FSM, after the customized rock physics library module 106 is built.

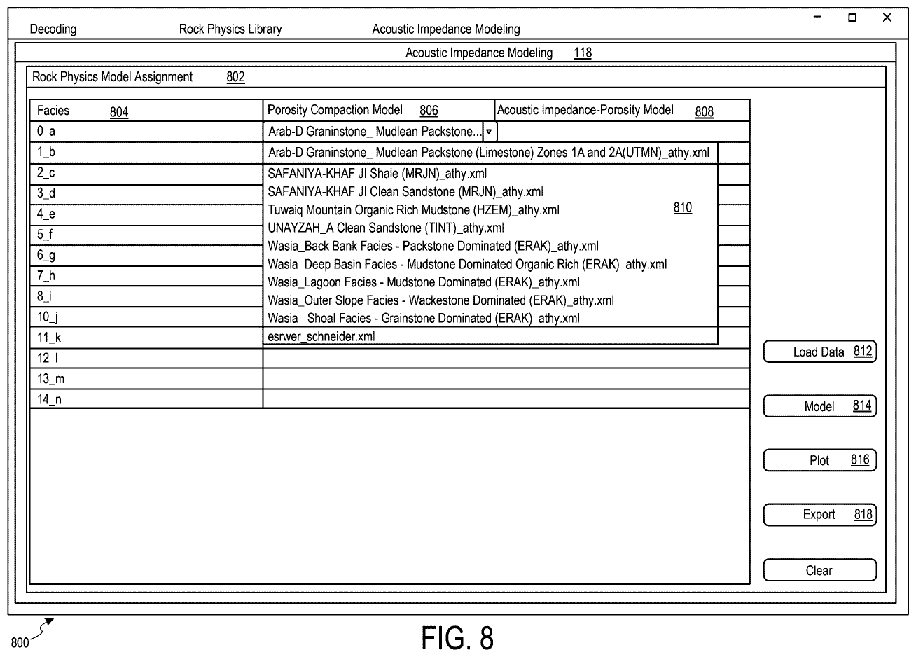

FIG. 8 illustrates an example interface 800 for loading decoded facies data 114 and saved customized rock physics models 116, according to some implementations. In some implementations, a user can select the “Load Data” button 812, and load decoded facies data 114 and customized rock physics models 116 into assignment table 802. The facies numbers 804, for example, the decoded facies numbers and/or the user-defined facies numbers, can be shown in assignment table 802. Assignment table 802 also shows the corresponding compaction-porosity model 806 and the acoustic impedance-porosity model 808.

In some implementations, the input for the compaction-porosity model 806 and the acoustic impedance-porosity model 808 can be selected from a drop-down menu, e.g., drop-down menu 810, that shows all the models defined in the rock physics library module 106.

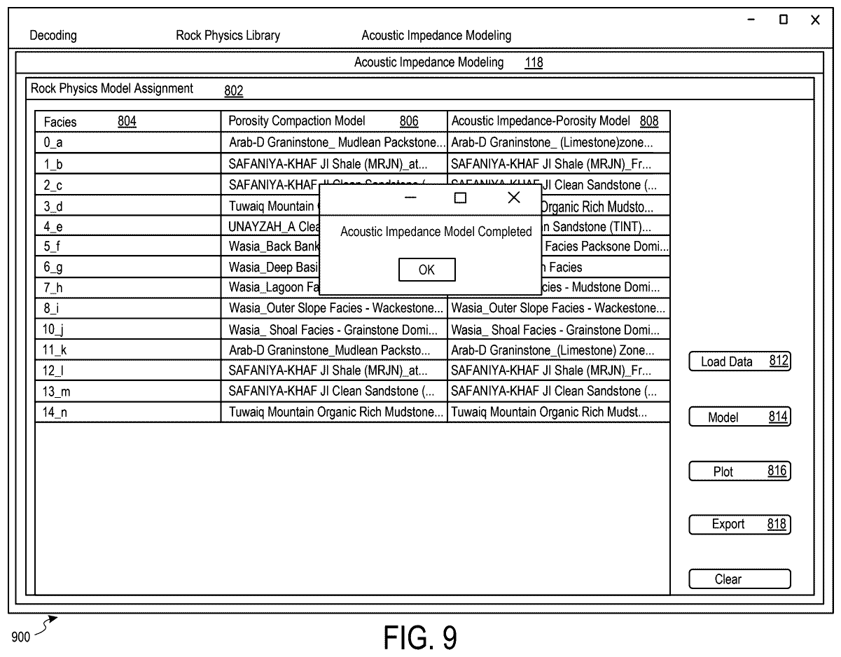

FIG. 9 illustrates an example interface 900 that shows the determined acoustic impedance, according to some implementations. In some implementations, acoustic impedance can be determined after a user selects the “Model” button 814 after assigning rock physics models in rock physics library module 106.

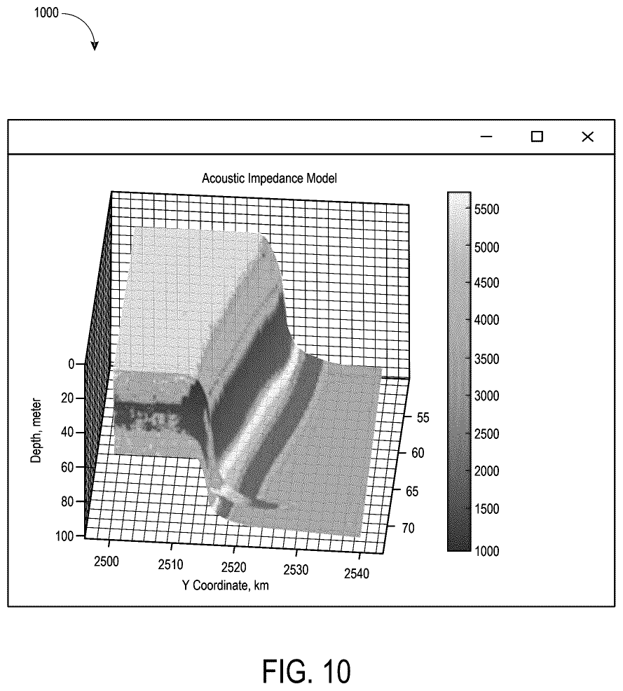

FIG. 10 illustrates an example 1000 of 3D surface mapping of acoustic impedance model in layers, according to some implementations. In some implementations, a user can select the “Plot” button 816 in FIG. 8 to display a 3D surface of determined acoustic impedance.

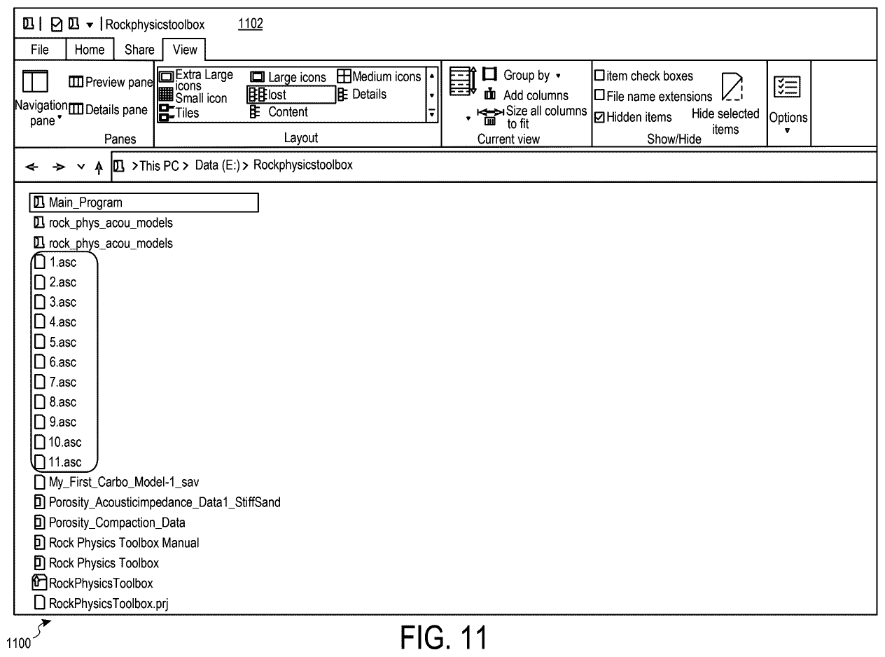

FIG. 11 illustrates an example 1100 of exported ASCII files of a determined acoustic impedance model, according to some implementations. In some implementations, a user can select the “Export” button 818 in FIG. 8 to save ASCII files to a folder (e.g., folder “Rockphysicstoolbox” 1102 in FIG. 11). Several ASCII files can be saved in the folder and the file names (e.g., 1.asc, 2.asc, 3.asc, etc. in FIG. 11) can be numbered in order. The ASCII files can represent the layers in the determined acoustic impedance model in a specific direction, for example, from the top layer to the bottom layer. The numbering of the file names can ascend from the top layer to the bottom layer.

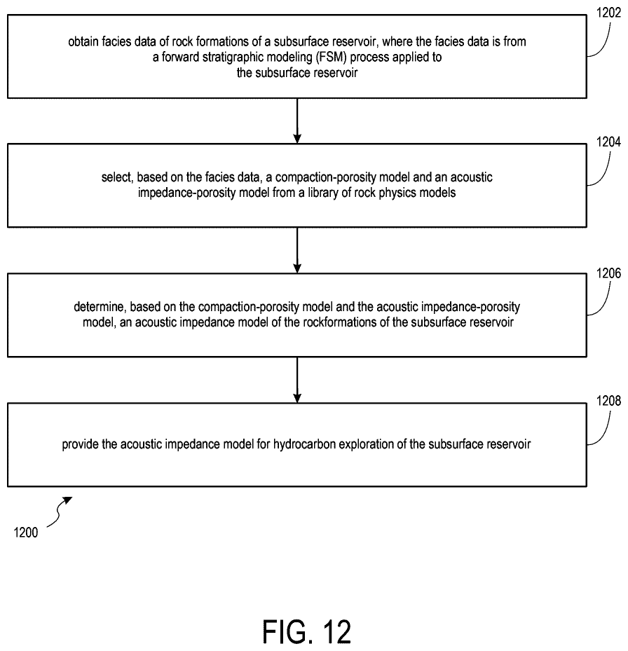

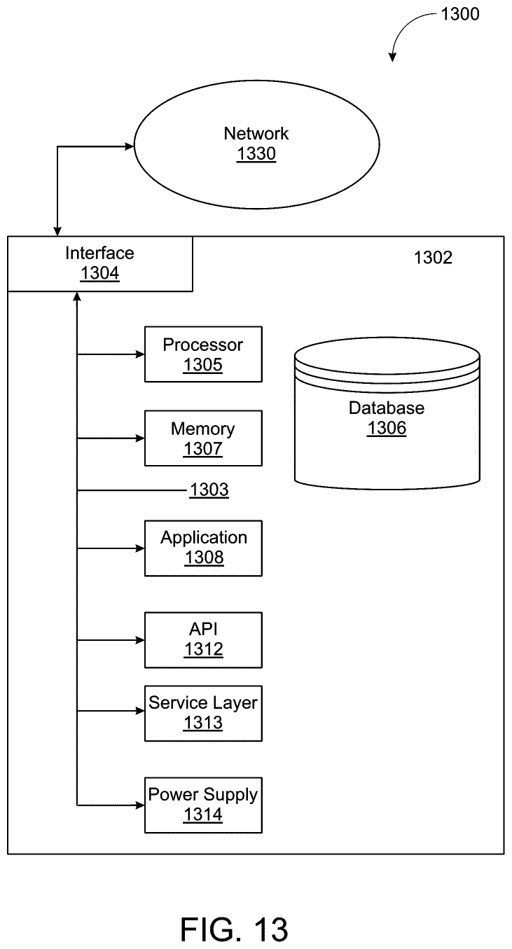

FIG. 12 illustrates an example process 1200 for an example process of determining acoustic impedance based on forward stratigraphic modeling, according to some implementations. For convenience, process 1200 will be described as being performed by a computer system having one or more computers located in one or more locations and programmed appropriately in accordance with this specification. An example of the computer system is the computer system 1300 illustrated in FIG. 13.

At 1202, a computer system obtains facies data of rock formations of a subsurface reservoir, where the facies data is from a FSM process applied to the subsurface reservoir.

At 1204, the computer system selects, based on the facies data, a compaction-porosity model and an acoustic impedance-porosity model from a library of rock physics models.

At 1206, the computer system determines, based on the compaction-porosity model and the acoustic impedance-porosity model, an acoustic impedance model of the rock formations of the subsurface reservoir.

At 1208, the computer system provides the acoustic impedance model for hydrocarbon exploration of the subsurface reservoir.

FIG. 13 is a block diagram of an example computer system 1300 that can be used to provide computational functionalities associated with described algorithms, methods, functions, processes, flows, and procedures, according to some implementations of the present disclosure. In some implementations, the computer system performing process 1200 can be the computer system 1300, include the computer system 1300, or the computer system performing process 1200 can communicate with the computer system 1300.

The illustrated computer 1302 is intended to encompass any computing device such as a server, a desktop computer, an embedded computer, a laptop/notebook computer, a wireless data port, a smart phone, a personal data assistant (PDA), a tablet computing device, or one or more processors within these devices, including physical instances, virtual instances, or both. The computer 1302 can include input devices such as keypads, keyboards, and touch screens that can accept user information. Also, the computer 1302 can include output devices that can convey information associated with the operation of the computer 1302. The information can include digital data, visual data, audio information, or a combination of information. The information can be presented in a graphical user interface (UI) (or GUI). In some implementations, the inputs and outputs include display ports (such as DVI-I+2x display ports), USB 3.0, GbE ports, isolated DI/O, SATA-III (6.0 Gb/s) ports, mPCIe slots, a combination of these, or other ports. In instances of an edge gateway, the computer 1302 can include a Smart Embedded Management Agent (SEMA), such as a built-in ADLINK SEMA 2.2, and a video sync technology, such as Quick Sync Video technology supported by ADLINK MSDK+. In some examples, the computer 1302 can include the MXE-5400 Series processor-based fanless embedded computer by ADLINK, though the computer 1302 can take other forms or include other components.

The computer 1302 can serve in a role as a client, a network component, a server, a database, a persistency, or components of a computer system for performing the subject matter described in the present disclosure. The illustrated computer 1302 is communicably coupled with a network 1330. In some implementations, one or more components of the computer 1302 can be configured to operate within different environments, including cloud-computing-based environments, local environments, global environments, and combinations of environments.

At a high level, the computer 1302 is an electronic computing device operable to receive, transmit, process, store, and manage data and information associated with the described subject matter. According to some implementations, the computer 1302 can also include, or be communicably coupled with, an application server, an email server, a web server, a caching server, a streaming data server, or a combination of servers.

The computer 1302 can receive requests over network 1330 from a client application (for example, executing on another computer 1302). The computer 1302 can respond to the received requests by processing the received requests using software applications. Requests can also be sent to the computer 1302 from internal users (for example, from a command console), external (or third) parties, automated applications, entities, individuals, systems, and computers.

Each of the components of the computer 1302 can communicate using a system bus 1303. In some implementations, any or all of the components of the computer 1302, including hardware or software components, can interface with each other or the interface 1304 (or a combination of both), over the system bus. Interfaces can use an application programming interface (API) 1312, a service layer 1313, or a combination of the API 1312 and service layer 1313. The API 1312 can include specifications for routines, data structures, and object classes.

The API 1312 can be either computer-language independent or dependent. The API 1312 can refer to a complete interface, a single function, or a set of APIs 1312.

The service layer 1313 can provide software services to the computer 1302 and other components (whether illustrated or not) that are communicably coupled to the computer 1302. The functionality of the computer 1302 can be accessible for all service consumers using this service layer 1313. Software services, such as those provided by the service layer 1313, can provide reusable, defined functionalities through a defined interface. For example, the interface can be software written in JAVA, C++, or a language providing data in extensible markup language (XML) format. While illustrated as an integrated component of the computer 1302, in alternative implementations, the API 1312 or the service layer 1313 can be stand-alone components in relation to other components of the computer 1302 and other components communicably coupled to the computer 1302. Moreover, any or all parts of the API 1312 or the service layer 1313 can be implemented as child or sub-modules of another software module, enterprise application, or hardware module without departing from the scope of the present disclosure.

The computer 1302 can include an interface 1304. Although illustrated as a single interface 1304 in FIG. 13, two or more interfaces 1304 can be used according to particular needs, desires, or particular implementations of the computer 1302 and the described functionality. The interface 1304 can be used by the computer 1302 for communicating with other systems that are connected to the network 1330 (whether illustrated or not) in a distributed environment. Generally, the interface 1304 can include, or be implemented using, logic encoded in software or hardware (or a combination of software and hardware) operable to communicate with the network 1330. More specifically, the interface 1304 can include software supporting one or more communication protocols associated with communications. As such, the network 1330 or the interface's hardware can be operable to communicate physical signals within and outside of the illustrated computer 1302.

The computer 1302 includes a processor 1305. Although illustrated as a single processor 1305 in FIG. 13, two or more processors 1305 can be used according to particular needs, desires, or particular implementations of the computer 1302 and the described functionality. Generally, the processor 1305 can execute instructions and manipulate data to perform the operations of the computer 1302, including operations using algorithms, methods, functions, processes, flows, and procedures as described in the present disclosure.

The computer 1302 can also include a database 1306 that can hold data for the computer 1302 and other components connected to the network 1330 (whether illustrated or not). For example, database 1306 can be an in-memory, conventional, or a database storing data consistent with the present disclosure. In some implementations, the database 1306 can be a combination of two or more different database types (for example, hybrid in-memory and conventional databases) according to particular needs, desires, or particular implementations of the computer 1302 and the described functionality. Although illustrated as a single database 1306 in FIG. 13, two or more databases (of the same, different, or combination of types) can be used according to particular needs, desires, or particular implementations of the computer 1302 and the described functionality. While database 1306 is illustrated as an internal component of the computer 1302, in alternative implementations, database 1306 can be external to the computer 1302.

The computer 1302 also includes a memory 1307 that can hold data for the computer 1302 or a combination of components connected to the network 1330 (whether illustrated or not). Memory 1307 can store any data consistent with the present disclosure. In some implementations, memory 1307 can be a combination of two or more different types of memory (for example, a combination of semiconductor and magnetic storage) according to particular needs, desires, or particular implementations of the computer 1302 and the described functionality. Although illustrated as a single memory 1307 in FIG. 13, two or more memories 1307 (of the same, different, or combination of types) can be used according to particular needs, desires, or particular implementations of the computer 1302 and the described functionality. While memory 1307 is illustrated as an internal component of the computer 1302, in alternative implementations, memory 1307 can be external to the computer 1302.

An application 1308 can be an algorithmic software engine providing functionality according to particular needs, desires, or particular implementations of the computer 1302 and the described functionality. For example, an application 1308 can serve as one or more components, modules, or applications 1308. Multiple applications 1308 can be implemented on the computer 1302. Each application 1308 can be internal or external to the computer 1302.

The computer 1302 can also include a power supply 1314. The power supply 1314 can include a rechargeable or non-rechargeable battery that can be configured to be either user- or non-user-replaceable. In some implementations, the power supply 1314 can include power-conversion and management circuits, including recharging, standby, and power management functionalities. In some implementations, the power-supply 1314 can include a power plug to allow the computer 1302 to be plugged into a wall socket or a power source to, for example, power the computer 1302 or recharge a rechargeable battery.

There can be any number of computers 1302 associated with, or external to, a computer system including computer 1302, with each computer 1302 communicating over network 1330. Further, the terms “client”, “user”, and other appropriate terminology can be used interchangeably without departing from the scope of the present disclosure. Moreover, the present disclosure contemplates that many users can use one computer 1302 and one user can use multiple computers 1302.

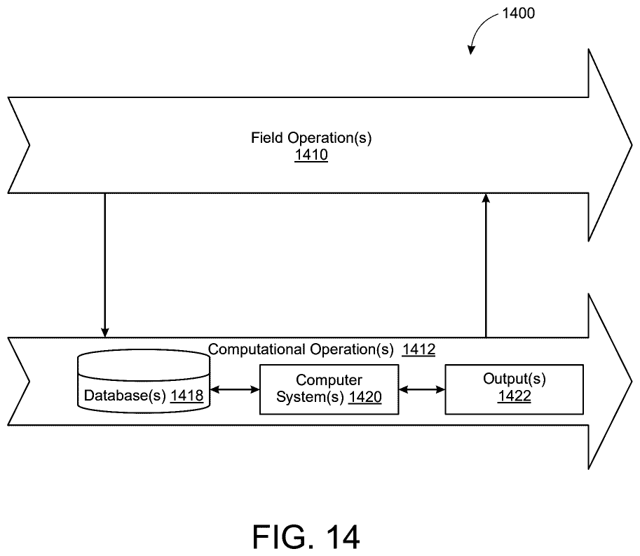

FIG. 14 illustrates hydrocarbon production operations 1400 that include both one or more field operations 1410 and one or more computational operations 1412, which exchange information and control exploration for the production of hydrocarbons, according to some implementations. In some implementations, outputs of techniques of the present disclosure can be performed before, during, or in combination with the hydrocarbon production operations 1400, specifically, for example, either as field operations 1410 or computational operations 1412, or both.

Examples of field operations 1410 include forming/drilling a wellbore, hydraulic fracturing, producing through the wellbore, injecting fluids (such as water) through the wellbore, to name a few. In some implementations, methods of the present disclosure can trigger or control the field operations 1410. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1410 and responsively triggering the field operations 1410 including, for example, generating plans and signals that provide feedback to and control physical components of the field operations 1410. Alternatively, or in addition, the field operations 1410 can trigger the methods of the present disclosure. For example, implementing physical components (including, for example, hardware, such as sensors) deployed in the field operations 1410 can generate plans and signals that can be provided as input or feedback (or both) to the methods of the present disclosure.

Examples of computational operations 1412 include one or more computer systems 1420 that include one or more processors and computer-readable media (e.g., non-transitory computer-readable media) operatively coupled to the one or more processors to execute computer operations to perform the methods of the present disclosure. The computational operations 1412 can be implemented using one or more databases 1418, which store data received from the field operations 1410 and/or generated internally within the computational operations 1412 (e.g., by implementing the methods of the present disclosure) or both. For example, the one or more computer systems 1420 process inputs from the field operations 1410 to assess conditions in the physical world, the outputs of which are stored in the databases 1418. For example, seismic sensors of the field operations 1410 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1412 where they are stored in the databases 1418 and analyzed by the one or more computer systems 1420.

In some implementations, one or more outputs 1422 generated by the one or more computer systems 1420 can be provided as feedback/input to the field operations 1410 (either as direct input or stored in the databases 1418). The field operations 1410 can use the feedback/input to control physical components used to perform the field operations 1410 in the real world.

For example, the computational operations 1412 can process the seismic data to generate three-dimensional maps of the subsurface formation. The computational operations 1412 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1412 to process new information about the formation and control the drilling to adjust to the observed conditions in real-time.

The one or more computer systems 1420 can update the 3D maps of the subsurface formation as information from one exploration well is received and the computational operations 412 can adjust the location of the next exploration well based on the updated 3D maps. Similarly, the data received from production operations can be used by the computational operations 1412 to control components of the production operations. For example, production well and pipeline data can be analyzed to predict slugging in pipelines leading to a refinery and the computational operations 1412 can control machine operated valves upstream of the refinery to reduce the likelihood of plant disruptions that run the risk of taking the plant offline.

In some implementations of the computational operations 1412, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

Implementations of the subject matter and the functional operations described in this specification can be implemented in digital electronic circuitry, in tangibly embodied computer software or firmware; in computer hardware, including the structures disclosed in this specification and their structural equivalents; or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus”, “computer”, and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus and special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, Linux, Unix, Windows, Mac OS, Android, or iOS.

A computer program, which can also be referred to or described as a program, software, a software application, a module, a software module, a script, or code can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document; in a single file dedicated to the program in question; or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes; the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks, optical memory devices, and technologies including, for example, digital video disc (DVD), CD ROM, DVD+/−R, DVD-RAM, DVD-ROM, HD-DVD, and BLU-RAY.

The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), or a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser. Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, or in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations; and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

### Embodiments

Embodiment 1: A computer-implemented method including obtaining facies data of rock formations of a subsurface reservoir, where the facies data is from a forward stratigraphic modeling (FSM) process applied to the subsurface reservoir. A compaction-porosity model and an acoustic impedance-porosity model are selected from a library of rock physics models based on the facies data. An acoustic impedance model of the rock formations of the subsurface reservoir is determined based on the compaction-porosity model and the acoustic impedance-porosity model. The acoustic impedance model is provided for hydrocarbon exploration of the subsurface reservoir.

Embodiment 2: The computer-implemented method of embodiment 1, where obtaining the facies data of rock formations includes decoding the facies data to obtain decoded facies data of the rock formations of the subsurface reservoir, and a format of the decoded facies data is compatible with the acoustic impedance-porosity model.

Embodiment 3: The computer-implemented method of embodiment 2, where selecting, based on the facies data, the compaction-porosity model and the acoustic impedance-porosity model includes selecting, based on the decoded facies data, the compaction-porosity model and the acoustic impedance-porosity model.

Embodiment 4: The computer-implemented method of any one of embodiments 1 to 3, selecting the compaction-porosity model and the acoustic impedance-porosity model includes selecting, based on input data from a graphical user interface (GUI), the compaction-porosity model and the acoustic impedance-porosity model.

Embodiment 5: The computer-implemented method of any one of embodiments 1 to 4, where at least one of the compaction-porosity model or the acoustic impedance-porosity model is a customized model from a user.

Embodiment 6: The computer-implemented method of any one of embodiments 1 to 5, where the compaction-porosity model includes a porosity-depth function of the rock formations, and the porosity-depth function is based on Athy's law or a Schneider model.

Embodiment 7: The computer-implemented method of any one of embodiments 1 to 6, where the acoustic impedance-porosity model includes an acoustic impedance-porosity function of the rock formations, and the acoustic impedance-porosity function is based on one of a stiff sand model, a friable sand model, a constant cement model, a differential effective medium model, and an empirical model.

Embodiment 8: A non-transitory computer-readable medium storing one or more instructions executable by a computer system to perform operations including obtaining facies data of rock formations of a subsurface reservoir, where the facies data is from a forward stratigraphic modeling (FSM) process applied to the subsurface reservoir. A compaction-porosity model and an acoustic impedance-porosity model are selected from a library of rock physics models based on the facies data. An acoustic impedance model of the rock formations of the subsurface reservoir is determined based on the compaction-porosity model and the acoustic impedance-porosity model. The acoustic impedance model is provided for hydrocarbon exploration of the subsurface reservoir.

Embodiment 9: The non-transitory computer-readable medium of embodiment 8, where obtaining the facies data of rock formations includes decoding the facies data to obtain decoded facies data of the rock formations of the subsurface reservoir, and a format of the decoded facies data is compatible with the acoustic impedance-porosity model.

Embodiment 10: The non-transitory computer-readable medium of embodiment 9, where selecting, based on the facies data, the compaction-porosity model and the acoustic impedance-porosity model includes selecting, based on the decoded facies data, the compaction-porosity model and the acoustic impedance-porosity model.

Embodiment 11: The non-transitory computer-readable medium of any one of embodiments 8 to 10, where selecting the compaction-porosity model and the acoustic impedance-porosity model includes selecting, based on input data from a graphical user interface (GUI), the compaction-porosity model and the acoustic impedance-porosity model.

Embodiment 12: The non-transitory computer-readable medium of any one of embodiments 8 to 11, where at least one of the compaction-porosity model or the acoustic impedance-porosity model is a customized model from a user.

Embodiment 13: The non-transitory computer-readable medium of any one of embodiments 8 to 12, where the compaction-porosity model includes a porosity-depth function of the rock formations, and the porosity-depth function is based on Athy's law or a Schneider model.

Embodiment 14: The non-transitory computer-readable medium of any one of embodiments 8 to 13, where the acoustic impedance-porosity model includes an acoustic impedance-porosity function of the rock formations, and the acoustic impedance-porosity function is based on one of a stiff sand model, a friable sand model, a constant cement model, a differential effective medium model, and an empirical model.

Embodiment 15: A computer-implemented system, including one or more computers; and one or more computer memory devices interoperably coupled with the one or more computers and having tangible, non-transitory, machine-readable media storing one or more instructions that, when executed by the one or more computers, perform one or more operations including obtaining facies data of rock formations of a subsurface reservoir, where the facies data is from a forward stratigraphic modeling (FSM) process applied to the subsurface reservoir. A compaction-porosity model and an acoustic impedance-porosity model are selected from a library of rock physics models based on the facies data. An acoustic impedance model of the rock formations of the subsurface reservoir is determined based on the compaction-porosity model and the acoustic impedance-porosity model. The acoustic impedance model is provided for hydrocarbon exploration of the subsurface reservoir.

Embodiment 16: The computer-implemented system of embodiment 15, where obtaining the facies data of rock formations includes decoding the facies data to obtain decoded facies data of the rock formations of the subsurface reservoir, and a format of the decoded facies data is compatible with the acoustic impedance-porosity model.

Embodiment 17: The computer-implemented system of embodiment 16, where selecting, based on the facies data, the compaction-porosity model and the acoustic impedance-porosity model includes selecting, based on the decoded facies data, the compaction-porosity model and the acoustic impedance-porosity model.

Embodiment 18: The computer-implemented system of any one of embodiments 15 to 17, where selecting the compaction-porosity model and the acoustic impedance-porosity model includes selecting, based on input data from a graphical user interface (GUI), the compaction-porosity model and the acoustic impedance-porosity model.

Embodiment 19: The computer-implemented system of any one of embodiments 15 to 18, where at least one of the compaction-porosity model or the acoustic impedance-porosity model is a customized model from a user.

Embodiment 20: The computer-implemented system of any one of embodiments 15 to 19, where the compaction-porosity model includes a porosity-depth function of the rock formations, and the porosity-depth function is based on Athy's law or a Schneider model.

What is claimed is:

1. A computer-implemented method, comprising:
obtaining facies data of rock formations of a subsurface reservoir, wherein the facies data is from a forward stratigraphic modeling (FSM) process applied to the subsurface reservoir;
selecting, based on the facies data, a compaction-porosity model and an acoustic impedance-porosity model from a library of rock physics models;
determining, based on the compaction-porosity model and the acoustic impedance-porosity model, an acoustic impedance model of the rock formations of the subsurface reservoir; and
providing the acoustic impedance model for hydrocarbon exploration of the subsurface reservoir.

2. The computer-implemented method of claim 1, wherein obtaining the facies data of rock formations comprises decoding the facies data to obtain decoded facies data of the rock formations of the subsurface reservoir, and a format of the decoded facies data is compatible with the acoustic impedance-porosity model.

3. The computer-implemented method of claim 2, wherein selecting, based on the facies data, the compaction-porosity model and the acoustic impedance-porosity model comprises selecting, based on the decoded facies data, the compaction-porosity model and the acoustic impedance-porosity model.

4. The computer-implemented method of claim 1, wherein selecting the compaction-porosity model and the acoustic impedance-porosity model comprises selecting, based on input data from a graphical user interface (GUI), the compaction-porosity model and the acoustic impedance-porosity model.

5. The computer-implemented method of claim 1, wherein at least one of the compaction-porosity model or the acoustic impedance-porosity model is a customized model from a user.

6. The computer-implemented method of claim 1, wherein the compaction-porosity model comprises a porosity-depth function of the rock formations, and the porosity-depth function is based on Athy's law or a Schneider model.

7. The computer-implemented method of claim 1, wherein the acoustic impedance-porosity model comprises an acoustic impedance-porosity function of the rock formations, and the acoustic impedance-porosity function is based on one of a stiff sand model, a friable sand model, a constant cement model, a differential effective medium model, and an empirical model.

8. A non-transitory computer-readable medium storing one or more instructions executable by a computer system to perform operations comprising:
obtaining facies data of rock formations of a subsurface reservoir, wherein the facies data is from a forward stratigraphic modeling (FSM) process applied to the subsurface reservoir;
selecting, based on the facies data, a compaction-porosity model and an acoustic impedance-porosity model from a library of rock physics models;
determining, based on the compaction-porosity model and the acoustic impedance-porosity model, an acoustic impedance model of the rock formations of the subsurface reservoir; and
providing the acoustic impedance model for hydrocarbon exploration of the subsurface reservoir.

9. The non-transitory computer-readable medium of claim 8, wherein obtaining the facies data of rock formations comprises decoding the facies data to obtain decoded facies data of the rock formations of the subsurface reservoir, and a format of the decoded facies data is compatible with the acoustic impedance-porosity model.

10. The non-transitory computer-readable medium of claim 9, wherein selecting, based on the facies data, the compaction-porosity model and the acoustic impedance-porosity model comprises selecting, based on the decoded facies data, the compaction-porosity model and the acoustic impedance-porosity model.

11. The non-transitory computer-readable medium of claim 8, wherein selecting the compaction-porosity model and the acoustic impedance-porosity model comprises selecting, based on input data from a graphical user interface (GUI), the compaction-porosity model and the acoustic impedance-porosity model.

12. The non-transitory computer-readable medium of claim 8, wherein at least one of the compaction-porosity model or the acoustic impedance-porosity model is a customized model from a user.

13. The non-transitory computer-readable medium of claim 8, wherein the compaction-porosity model comprises a porosity-depth function of the rock formations, and the porosity-depth function is based on Athy's law or a Schneider model.

14. The non-transitory computer-readable medium of claim 8, wherein the acoustic impedance-porosity model comprises an acoustic impedance-porosity function of the rock formations, and the acoustic impedance-porosity function is based on one of a stiff sand model, a friable sand model, a constant cement model, a differential effective medium model, and an empirical model.

15. A computer-implemented system comprising:
one or more computers; and
one or more computer memory devices interoperably coupled with the one or more computers and having tangible, non-transitory, machine-readable media storing one or more instructions that, when executed by the one or more computers, cause the computer-implemented system to perform one or more operations comprising:
obtaining facies data of rock formations of a subsurface reservoir, wherein the facies data is from a forward stratigraphic modeling (FSM) process applied to the subsurface reservoir;
selecting, based on the facies data, a compaction-porosity model and an acoustic impedance-porosity model from a library of rock physics models;
determining, based on the compaction-porosity model and the acoustic impedance-porosity model, an acoustic impedance model of the rock formations of the subsurface reservoir; and
providing the acoustic impedance model for hydrocarbon exploration of the subsurface reservoir.

16. The computer-implemented system of claim 15, wherein obtaining the facies data of rock formations comprises decoding the facies data to obtain decoded facies data of the rock formations of the subsurface reservoir, and a format of the decoded facies data is compatible with the acoustic impedance-porosity model.

17. The computer-implemented system of claim 16, wherein selecting, based on the facies data, the compaction-porosity model and the acoustic impedance-porosity model comprises selecting, based on the decoded facies data, the compaction-porosity model and the acoustic impedance-porosity model.

18. The computer-implemented system of claim 15, wherein selecting the compaction-porosity model and the acoustic impedance-porosity model comprises selecting, based on input data from a graphical user interface (GUI), the compaction-porosity model and the acoustic impedance-porosity model.

19. The computer-implemented system of claim 15, wherein at least one of the compaction-porosity model or the acoustic impedance-porosity model is a customized model from a user.

20. The computer-implemented system of claim 15, wherein the compaction-porosity model comprises a porosity-depth function of the rock formations, and the porosity-depth function is based on Athy's law or a Schneider model.
